(19) United States
(12) Patent Application Publication
(10) Pub. No.: US 2022/0141374 A1
(43) Pub. Date: May 5, 2022

(54) INTELLIGENT FLASH INTENSITY CONTROL SYSTEMS AND METHODS

(71) Applicant: GUANGDONG OPPO MOBILE TELECOMMUNICATIONS CORP., LTD., Dongguan (CN)

(72) Inventors: Kaushal Prakash SHARMA, Hyderabad (IN); Nitin SETIA, Hyderabad (IN)

(73) Assignee: GUANGDONG OPPO MOBILE TELECOMMUNICATIONS CORP., LTD., Dongguan (CN)

(21) Appl. No.: 17/562,583

(22) Filed: Dec. 27, 2021

Related U.S. Application Data
(63) Continuation of application No. PCT/CN2020/090160, filed on May 14, 2020.

(30) Foreign Application Priority Data
Jul. 17, 2019 (IN) 201941028724

(51) Int. Cl. H04N 5/235

(52) U.S. Cl. CPC H04N 5/2354; H04N 5/2351

(57) ABSTRACT

A system and method for intelligent flash intensity control are provided. The method includes that: receiving an input from a user to open a camera [206] to capture a media. Thereafter, a position of a lens [206B] of the camera [206] is determined and a luminance level of a preview frame is detected. Further, a scene type for the preview frame is determined. Thereafter, a flash intensity control value is dynamically calculated based on the determined position of the lens [206B], the detected luminance level and the determined scene type. The flash intensity control value is then used to produce a flash, with an intensity value equal to the value of the flash intensity control, to capture the media.

### CROSS-REFERENCE TO RELATED APPLICATIONS

This application is a continuation of International Application No. PCT/CN2020/090160, filed on May 14, 2020, which claims priority to Indian Patent Application No. 201941028724, filed on Jul. 17, 2019. The disclosures of the aforementioned applications are hereby incorporated by reference in their entireties.

### FIELD

The present disclosure relates generally to electronic digital cameras, and more particularly, to a system and method for intelligent flash intensity control in a camera.

### BACKGROUND

The following description of related art is intended to provide background information pertaining to the field of the disclosure. This section may include certain aspects of the art that may be related to various features of the present disclosure. However, it should be appreciated that this section be used only to enhance the understanding of the reader with respect to the overall field of the present disclosure, and not as admissions of prior art.

Many different techniques have evolved to provide for optimum exposure to a scene to capture a photo of the scene using a conventional digital camera. Such techniques vary from the use of physical light meters separate from the camera to provide for the optimum amount of light, to systems involving the use of an artificial light emitted by the camera. The digital cameras may have an electronic flash unit in the camera to fire an artificial light emitted by the camera, that is, a flash to the scene. Some digital cameras also provide a device for mechanical adjustment for controlling the flash. In these systems, the flash is dependent on the skill of the user of the digital camera. Further, the burden of adjusting for exposure may be placed entirely on the camera aperture and shutter speed in some systems. Also, in these systems, the amount of flash is not at all controlled and the same amount of flash light is emitted by the camera irrespective of the conditions of the scene.

Further, many devices may simply provide for a flash of long duration and depend on the conventional exposure systems to function for ambient lighting in all scenarios. These cameras do not control amount of flash time to achieve proper exposure. Therefore, these cameras consume a larger amount of power and in some instances produce overexposed and unnatural looking images. Also, in such systems, the flash produced may be concentrated in a spot in a photo and will not be evenly distributed. Therefore, the resultant images are overexposed with a bright white spot.

Further, there exists other systems, wherein there may be an option to adjust the exposure automatically by the camera, using the flash before clicking a photo. However, most of such systems suffer a time lag between the detection of optimum exposure and adjustment of the flash. For example, to capture a video in a fast moving train, it may involve capturing of various terrains having varying light exposure. In such a scenario, the exposure adjustment system may determine an optimum exposure for a particular scene. However, when the exposure adjustment is actually used or applied, the scene will have been changed to another terrain.

In other known flash systems, a flash may be used by the system prior to image acquisition to determine the optimum intensity flash required for an adequate exposure. These pre-flash systems may work independently from the image acquisition apparatus and may also depend on a predetermined look up table/database. Therefore, the accuracy of this system is dependent on the accuracy of the look up table/database and its exactness to the actual scene. For example, the predetermined lookup table may store values to provide for a high intensity flash for all outdoor scenes. However, a high intensity flash may not be required for all outdoor scenes. Further, such a camera requires a separate device for pre-flashing, making such cameras more expensive and heavier.

Additionally, another method of controlling the exposure in a photo involves the use of an infrared receptor to measure the light in the scene. This exposure control system requires a separate photo receptor to measure the light, which adds complexity and cost to the digital camera system. Further, the infrared receptor used in such a system may also measure the light as only a monochromatic estimation of the scenery.

An exemplary set of images captured using the known systems are illustrated in FIG. 1A, FIG. 1B and FIG. 1C. As evident from these figures, the images captured using existing systems contain white patches and are overexposed due to the various limitations discussed above.

Hence, the current systems result in images that may be overexposed, contain numerous white patches, and seem unnatural. None of the current digital camera systems provides for automatic adjustment of flash to produce natural, correctly exposed images for all types of scenes and lighting.

Therefore, it is apparent from the aforementioned problems and limitations that there exists a need to provide for an improved camera, that requires less power, less space and is relatively inexpensive while providing for natural and correctly exposed images. Further, there exists a need to provide for low light photography including the use of a flash. Additionally, the digital camera must provide for a distributed flash throughout the image.

### SUMMARY

This section is provided to introduce certain objects and aspects of the present disclosure in a simplified form that are further described below in the detailed description. This summary is not intended to identify the key features or the scope of the claimed subject matter. In order to overcome at least a few problems associated with the known solutions as provided in the previous section, an object of the present disclosure is to provide for an intelligent camera that produces natural and correctly exposed images with the use of flash. It is another object of the present disclosure to provide for a camera that requires less power, less space and is relatively inexpensive while providing for natural and correctly exposed images with the use of flash. It is yet another object of the present disclosure to provide for a camera that provides for low light photography including the use of a flash. It is yet another object of the present disclosure to provide for a camera that provides for a distributed flash throughout an image.

It is yet another object of the present disclosure to provide for a camera that dynamically determines an intensity of the flash to be used for capturing an image. It is yet another object of the present disclosure to provide for a camera that dynamically determines an intensity of the flash to be used for capturing an image using the position of a lens, wherein the position of the lens is determined when the lens is focused. It is yet another object of the present disclosure to provide for a camera that dynamically determines an intensity of the flash to be used for capturing an image using a luminance level of the scene and a scene type of the scene.

In view of the aforesaid objects of the present disclosure, a first aspect of the present disclosure relates to a method for intelligent flash intensity control in a camera. The method commences when an input is received from a user to capture a media, i.e. image or video, of a preview frame, based on which a position of the lens of the camera is determined. This position of the lens is determined based on a focal point of the lens. Further, a luminance level and a scene type of the preview frame are also determined. The method then includes dynamically calculating, via a flash control unit, a flash intensity control value for capturing the media, said flash intensity control value being calculated based on the position of the lens, the luminance level and the scene type.

Another aspect of the present disclosure relates to a camera having a function of intelligent flash intensity control, the camera comprising a camera interface connected to a camera driver. The camera interface is configured to receive an input to capture a media of a preview frame. Further, the camera driver is configured to determine a position of a lens for capturing the media and detect a luminance level of the preview frame. The system further comprises: a camera framework, connected to the camera interface and the camera driver, and configured to detect a scene type of the preview frame; and a flash control unit, connected to the camera driver and the camera framework, said flash control unit being configured to calculate a flash intensity control value based on at least one of the position of the lens, the luminance level and the scene type.

### BRIEF DESCRIPTION OF DRAWINGS

The accompanying drawings, which are incorporated herein, and constitute a part of the present disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes disclosure of electrical components or circuitry commonly used to implement such components. Although exemplary connections between sub-components have been illustrated in the accompanying drawings, it will be appreciated by those skilled in the art that other connections may also be possible, without departing from the scope of the present disclosure. All sub-components within a component may be connected to each other, unless otherwise indicated.

FIG. 1A, FIG. 1B and FIG. 1C illustrate an exemplary set of images captured using the prior art systems.

FIG. 2 illustrates an overview of an implementation of a camera having a function of intelligent flash intensity control, in accordance with exemplary embodiments of the present disclosure.

FIG. 3 illustrates an architecture of a camera for providing an intelligent flash intensity control, in accordance with exemplary embodiments of the present disclosure.

FIG. 4 illustrates a flow diagram depicting an exemplary method for an intelligent flash intensity control in a camera, in accordance with exemplary embodiments of the present disclosure.

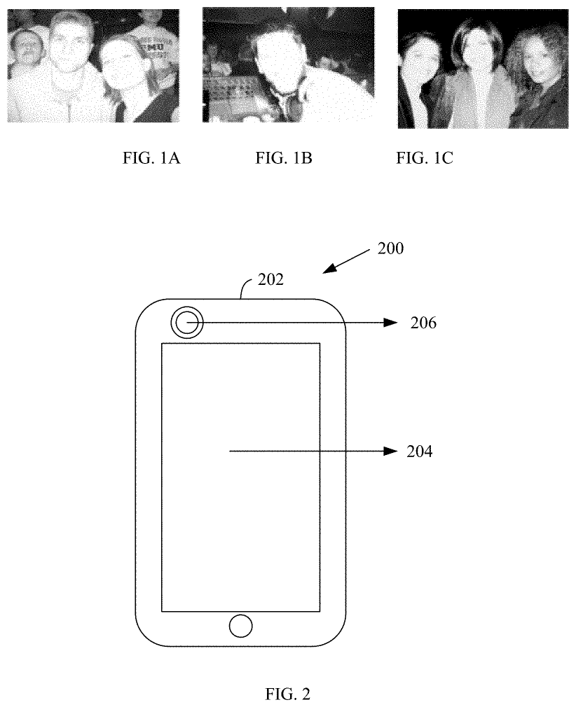

The foregoing shall be more apparent from the following more detailed description of the present disclosure.

### DESCRIPTION OF EMBODIMENTS

In the following description, for the purposes of explanation, various specific details are set forth in order to provide a thorough understanding of the embodiments of the present disclosure. It will be apparent, however, that embodiments of the present disclosure may be practiced without these specific details. Several features described hereafter can each be used independently of one another or with any combination of other features. An individual feature may not address any of the problems discussed above or might address only some of the problems discussed above. Some of the problems discussed above might not be fully addressed by any of the features described herein. Example embodiments of the present disclosure are described below, as illustrated in various drawings.

The present disclosure provides a method and system for an intelligent flash intensity control in a camera. An input is received from the user, by an input unit, to open a camera interface. The camera interface includes a preview frame and may include one or more options to be selected by the user for using a flash. The user then selects the “Auto Mode” to capture a media. Thereafter, the user sends an input to capture a media. A shutter of the camera is then opened, and light is allowed to pass through a lens of the camera. In the Auto Mode to capture the media, a camera driver determines a position of a lens of the camera when the light passing through the lens is focused on an image sensor. The camera driver also detects a luminance level based on the amount of light present in the preview frame. Further, a camera framework determines a scene type for the preview frame. As used herein in this disclosure, a “scene type” may comprise outdoor, indoor, day, night, star, dark, bright, beach and sea. Thereafter, the determined lens position of the lens, the detected luminance level and the determined scene type are transmitted to a flash control unit to dynamically calculate a flash intensity control value. The flash intensity control value is then sent to a flash driver to produce a flash, with an intensity equal to the value of the flash intensity control, to capture a media.

As used herein, “connect”, “configure”, “couple” and its cognate terms, such as “connects”, “connected”, “configured” and “coupled” may include a physical connection (such as a wired/wireless connection), a logical connection (such as through logical gates of semiconducting device), other suitable connections, or a combination of such connections, as may be obvious to a skilled person.

As used herein, “send”, “transfer”, “transmit”, and their cognate terms like “sending”, “sent”, “transferring”, “transmitting”, “transferred”, “transmitted”, etc. include sending or transporting data or information from one unit or component to another unit or component, wherein the data or information may or may not be modified before or after sending, transferring, transmitting.

Referring to FIG. 2, an exemplary implementation of a camera [206] for providing an intelligent flash intensity control is disclosed in accordance with exemplary embodiments of the present disclosure. As illustrated, the camera [206] may be implemented in an electronic device [202] comprising an input unit [204], a processor [108] (not illustrated in the figure) and a memory [110] (not illustrated in the figure). As used herein, the electronic device [202] refers to any electrical, electronic, electromechanical and computing device. The electronic device [202] may include, but is not limited to, a mobile phone, a smartphone, a tablet, a phone, a laptop, a wearable device, a personal digital assistant and any such device obvious to a person skilled in the art. It will be understood by those of ordinary skill in the art that the structure illustrated is merely illustrative and does not limit the structure of the electronic device [202]. The electronic device [202] may also include more or less components than those illustrated in FIG. 2 or have a different configuration than that illustrated in this FIG. 2.

The input unit [204] is connected to the camera [206] and the processor [108]. It will be understood by those of ordinary skill in the art that the input unit [204] and the camera [206] may be connected to each other using universal asynchronous receiver/transmitter (UART), general purpose input output (GPIO), serial peripheral interface (SPI), inter-integrated Circuit (I2C), but not limited to the above standards. In some examples, the connection may only include a bus, and in other examples, the connection may also include other components, such as one or more controllers.

The input unit [204] is configured to receive an input from the user to start the camera [206]. In an embodiment, input received from the user may be to start a camera application, which is connected to the camera [206], on the electronic device [202]. Further, the input unit [204] is also configured to receive an input to select an “Auto Mode” of the camera [206]. As used herein, “Auto Mode” refers to an option provided to the user, which when selected or enabled, also enables that the intelligent flash intensity control is implemented in any device, in accordance with the present disclosure.

The present disclosure encompasses that the input unit [204] may comprise a touch panel, a soft keypad, a hard keypad (including buttons) and the like. For example, the user may click a soft button on a touch panel of the input unit [204] to capture a media using the camera [206] of the electronic device [202]. In another example, the user may touch a camera icon on the touch panel to start a camera application on a launcher of the electronic device [202]. In yet another example, the user may tap on a red button on a touch panel using a finger to capture an image using the camera [206]. In another example, the user may tap on an option of Auto Mode on the touch panel using a finger, in order to enable the Auto Mode of the camera [206].

In a preferred embodiment, the input unit [204] may be configured to receive an input from the user via a graphical user interface on the touch panel. As used herein, a “graphical user interface” may be a user interface that allows a user of the electronic device [202] to interact with the electronic device [202] through graphical icons and visual indicators, such as secondary notation, and any combination thereof. For example, the input unit [204] may include a touch panel configured to collect the user's input via touch operation, thereon or near the surface of the touch panel, and using a finger or a stylus. The present disclosure encompasses that the detection of the touch on a graphical user interface of the input unit [204] can be realized by various types such as resistive, capacitive, infrared, and surface acoustic waves.

The input unit [204] is further configured to transmit the input received from the user to the camera [206]. The input unit [204] is also configured to transmit the input received to the processor [108].

The camera [206] is configured to receive the input of the user via the input unit [204] and perform the desired operation. As used herein, the camera [206] may be any digital camera configured to perform the present disclosure in accordance with the present disclosure. The camera [206] is configured to provide a view of the scene to be captured in a preview frame. As used herein, a “preview frame” is a live view of a scene to the user which can be captured in a media using the camera [206]. This preview frame is the view of the scene to be captured limited to the coverage of the lens of the camera [206] and will dynamically change when the camera [206] is moved by the user. For example, the preview frame may be the live view of a scene, such as a bedroom, which is within the coverage area of a lens of the camera [206] and the preview frame may change to a playground when the camera [206] is moved to cover a view of the playground.

The camera [206] is configured to receive an input from the input unit [204] to capture a media. For example, the camera [206] may provide for a soft button to be clicked by the user to capture a media. The camera [206] may also provide for options to select the mode of operation of the flash. For example, the camera [206] may provide for an option to select the mode of operation of the flash to be the “Auto Mode”. The camera [206] is further configured to enable the Auto Mode when an input is received from the user. The camera [206] is also configured to capture a media when an input is received from the user. For example, the camera [206] is configured to capture a media when the user clicks on a ‘capture’ button via the graphical user interface. The present disclosure encompasses that the camera [206] is configured to capture a media in the “Auto Mode” when an input to capture a media is received from the user using the input unit [204]. For example, the user may select the “Auto Mode” and then click on a red button on the touch panel to capture a photo.

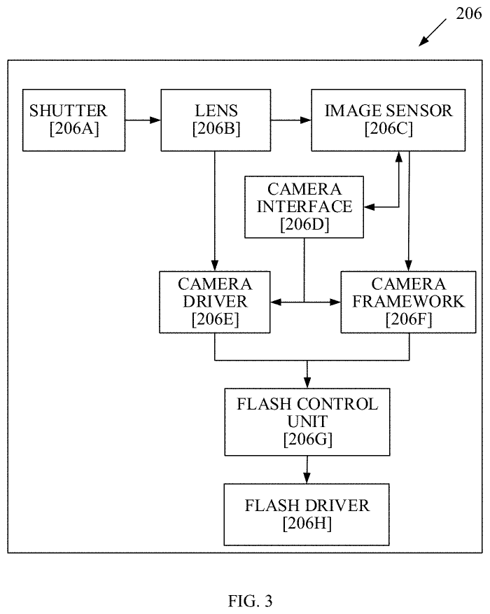

The camera [206] is also configured to determine a position of a lens of the camera [206] when the light passing through the lens is focused on an image sensor. The camera [206] is also configured to detect a luminance level for a preview frame to be captured. The camera [206] is further configured to determine a scene type for a preview frame to be captured. Further, the camera [206] is configured to dynamically calculate a flash intensity control value for capturing a media. The present disclosure encompasses that the flash intensity control value is based on a determined lens position of the lens of the camera [206], a detected luminance level and the determined scene type. The working of the camera [206] in accordance with the present disclosure is provided in detail herein below with reference to FIG. 3.

The processor is configured to control the overall working of the electronic device [202]. The processor is also configured to control the operation of the input unit [204] and the camera [206]. The processor is configured to provide for an interface for the transfer of data between the input unit [204] and the camera [206]. In an embodiment, the processor is configured to start a camera application when an input is received from the user via the input unit [204]. The processor may start the camera application based on one or more instructions stored in the memory. The processor may be further configured to provide for an interface between the camera application and the camera [206].

As used herein, a “processor” or “processing unit” includes one or more processors, wherein processor refers to any logic circuitry for processing instructions. A processor may be a general-purpose processor, a special purpose processor, a conventional processor, a digital signal processor, a plurality of microprocessors, one or more microprocessors in association with a digital signal processor (DSP) core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor or processing unit is a hardware processor.

The memory is configured to store software programs, modules, data, information, instructions and the like. The memory is further configured to allow the processor to execute various functional disclosures and data processing by running software programs and modules stored in the memory. The memory may include, but is not limited to, a volatile memory, non-volatile memory, a remote storage, a cloud storage, high-speed random-access memory and/or non-volatile memory, such as one or more magnetic disk storage devices, one or more optical storage devices, and/or flash memory (e.g., NAND, NOR) or a combination thereof. In some embodiments, the memory may further include a memory remotely configured relative to processor, which may be connected to the electronic device [202] and the processor via a network. Embodiments of such networks include, but are not limited to, the Internet, intranets, local area networks, mobile communication networks, and combinations thereof.

Although only one electronic device [202] has been illustrated in the FIG. 2, it will be appreciated by those skilled in the art that the present disclosure may be implemented in any number of electronic devices [202]. Further, the electronic device [202] may comprise more than one input units [204] and cameras [206].

Referring to FIG. 3, FIG. 3 illustrates an architecture of the camera [206] for providing an intelligent flash intensity control, in accordance with exemplary embodiments of the present disclosure. As depicted in FIG. 3, the camera [206] comprises a shutter [206A], a lens [206B], an image sensor [206C], a camera interface [206D], a camera driver [206E], a camera framework [206F], a flash control unit [206G] and a flash driver [206H].

The camera interface [206D] is configured to receive an input from the input unit [204] to capture a media from a preview frame of the camera [206]. In an embodiment, the camera interface [206D] may itself include an input mechanism for the user to capture a media. For example, the camera interface [206D] may provide for a button to capture a media, such as a photo. In another example, the user may select to capture a video using the camera interface [206D] by clicking on a button on the touch panel. Further, the camera interface [206D] may further include one or more buttons, icons or any input mechanism to provide one or more features for capturing a media. For example, the camera interface [206D] may further include one or more icons for providing filters, colours and the like.

The camera interface [206D] is also configured to provide one or more options for the flash of the camera [206]. The present disclosure encompasses that the camera interface [206D] includes an option for a mode of the flash to be the “Auto Mode”. The camera interface [206D] is further configured to interpret the input received from the user or from the input unit [204].

For instance, when an input is received from the user to select the “Auto Mode”, via the input unit [204], the camera interface [206D] is configured to interpret the input and transmit a signal to the camera driver [206E] and the camera framework [206F] to operate in the said mode. For example, the user may select the “Auto Mode” to capture a video using the camera [206]. In the “Auto Mode”, the camera [206] is configured to provide an intelligent flash intensity control value for the flash for capturing the video in accordance with the present disclosure. The camera interface [206D] is then configured to capture a media in the “Auto Mode” when an input to capture the media is received from the user.

The shutter [206A] is configured to open when the camera interface [206D] receives an input to capture a media. The shutter [206A] may be configured to be opened for a predetermined amount of time to allow the light rays from the scene to be captured to fall on the image sensor [206C] after passing through the lens [206B], and then be closed. For example, the shutter [206A] may be opened for 5 milliseconds and may thereafter be closed. The light passing through the shutter [206A] is made to pass through the lens [206B].

The lens [206B] is connected to the shutter [206A], the image sensor [206C] and the camera driver [206E]. As used herein, the lens [206B] may be a digital camera auto focus (AF) focusing lens, a standard prime lens, a zoom lens, a wide-angle lens, a telephoto, a fish-eye lens, an image stabilization lens and the like. The lens [206B] is configured to achieve a focus for the scene to be captured. The lens [206B] is place parallel to the shutter [206A] and the image sensor [10C] to achieve a focus for the scene to be captured on the image sensor [206C]. The lens [206B] allows the light rays coming through the shutter [206A] to pass through it. The present disclosure encompasses that the lens [206B] is moved to determine a focal point for the scene. As used herein, a “focal point” is the point of convergence of all the rays on the image sensor [206C]. The distance between the focal point and the lens [206B] is determined to be the focal range of the lens [206B]. In an embodiment, the focal range of the lens [206B] may be within a range from 30 mm to infinite. The present disclosure encompasses that the focal point of the lens [206B] is based on the distance between the scene to be captured and the lens [206B]. For example, the focal range of the lens [206B] will be shorter when the scene to be captured is near the lens [206B]. It will be obvious to a person in the art to know that a focus is achieved by moving the lens to achieve a clear view and definition of the preview frame.

The image sensor [206C], which is placed parallel to the lens [206B], is configured to be the point of convergence of the light rays passing through the lens [206B]. The image sensor [206C] is configured to be composed of a grid or array of photo pixels. The individual pixels on the image sensor [206C] are configured measure the intensity of the light falling on the image sensor [206C]. The image sensor [206C] then converts the light signal to a digital image or the preview frame. In an embodiment, each pixel of the image sensor [206C] may convert the light falling on each pixel into an energy value. The preview frame is then transmitted by the image sensor [206C] to the camera interface [206D] and is displayed to the user using the camera interface [206D].

The camera driver [206E], which is connected to the lens [206B], the image sensor [206C], the camera interface [206D] and the flash control unit [206G], is configured to receive a signal to operate in the “Auto Mode”. When the input to enable the “Auto Mode” is received from the user, the camera driver [206E] is configured to determine a position of the lens [206B] for capturing a media of the preview frame. The position of the lens [206B] is determined after the lens [206B] is moved to focus all the light rays passing through the lens [206B] on the image sensor [206C]. As used herein in present disclosure, a “focus” is the point on the axis of the lens [206B] to which parallel rays of light coming from the scene appear to converge or from which they appear to diverge after refraction or reflection, and provides a clear definition of the preview frame. Hence, the position of the lens [206B] is based on the focal point of the lens [206B]. The present disclosure encompasses that the focal point of the lens [206B] is based on the distance between the scene to be captured and the lens [206B]. For example, the focal range of the lens [206B] will be shorter when the scene to be captured is near the lens [206B]. The camera driver [206E] is further configured to transmit the determined position of the lens [206B] to the flash control unit [206G].

In an embodiment, the position of the lens [206B] may be determined to be within a predefined range. For example, the position of the lens [206B] may be determined to be within a range of 30 mm to infinite. For example, the position of the lens [206B] may be determined to be 40 mm.

The present disclosure also encompasses that the camera driver [206E] is configured to convert the determined position of the lens [206B] to a value within a scale of 1 to 10, the end values being inclusive. For example, the position of the lens [206B] may be determined by the camera driver [206E] to be 100 mm when focus is achieved to capture a photo. This determined value of the position of the lens is then converted to a value, say 5, from a scale of 1 to 10.

In an exemplary embodiment, the present disclosure encompasses that when an input is received from a user to capture a media, wherein the media includes capture of several consecutive preview frames, then the camera driver [206E] is configured to determine a position of the lens [206B] for capturing each of the several preview frames. For example, when an input to capture a video in the “Auto Mode” is received from the user, the camera driver [206E] is configured to determine a distinct position of the lens [206B] for capturing each of the several preview frames in video till the input to stop the video is received from the user. The camera driver [206E] may then convert the determined position of the lens [206B] for each of the preview frames captured in the video to a value within a scale of 1 to 10. For example, the camera driver [206E] may determine the position of the lens [206B] in respect of a preview frame of the video to be 250 mm. This determined value for this preview frame may be converted to a value, say 7. Thereafter, the camera driver [206E] may determine the position of the lens [206B] in respect of the next consecutive preview frame of the video to be 100 mm. This determined value for this next consecutive preview frame may be converted to a value, say 4.

Further, the camera driver [206E] is also configured to detect a luminance level of the scene in the Auto Mode. The luminance level of the preview frame is determined by the camera driver [206E] based on an amount of light in the preview frame. For example, the amount of light of a preview frame may be detected to be 10,000 lux which may then be used to determine a luminance level for the preview frame.

The present disclosure encompasses that the camera driver [206E] is configured to determine the amount of light in the preview frame based on the amount of light detected by the image sensor [206C]. The amount of light in the preview frame may be dependent on the amount of light received from the photo pixels of the image sensor [206C]. The present disclosure encompasses that the luminance level is then calculated using image processing by the camera driver [206E]. The camera driver [206E] may use rules of image processing, such as detection of the number of whites in the preview frame based on the light received by the image sensor [206C], to determine the amount of light present in a preview frame.

In an embodiment, the present disclosure encompasses that the determined luminance level by the camera driver [206E] is mapped onto a value within a scale from 1 to 10, the end values being inclusive. For example, the camera driver [206E] may detect the amount of light in a preview frame to be 10,000 lux. Then the camera driver [206E] may then determine a luminance level for the preview frame to capture a photo. Thereafter, the determined value of the preview frame may then be converted to a value, say 2, from a scale of 1 to 10.

In furtherance of the aforementioned exemplary embodiment, to capture a media involving the capture of several consecutive preview frames, the camera driver [206E] is also configured to detect a luminance level for capturing each of the several preview frames. For example, to capture a video in the “Auto Mode”, the camera driver [206E] is configured to detect a luminance level for capturing each of the several preview frames in video till the input to stop the video is received from the user. The camera driver [206E] may then convert the luminance level for each of the preview frames captured in the video to a value within a scale of 1 to 10. For example, the camera driver [206E] may detect the luminance level of a preview frame of the video to be converted to a value, say 7 when the amount of light in the preview frame is 10,000 lux. Thereafter, the camera driver [206E] may detect the luminance level of next consecutive preview frame of the video to be converted be a value, say 3, when the amount of light in the preview frame is say 100,000 lux.

The camera driver [206E] is further configured to transmit the detected luminance level of a preview frame to the flash control unit [206G].

The camera framework [206F], which is connected to the image sensor [206C], the camera driver [206E] and the flash control unit [206G], is configured to determine a scene type for the preview frame. As explained above, a “scene type” may comprise outdoor, indoor, day, night, star, dark, bright, beach and sea. For example, a preview frame including a sea and sand in the preview frame may be determined to be a scene type of a “beach”. In another example, a preview frame including walls and a bed in the background may be determined to be a scene type of “indoor”. The camera framework [206F] is further configured to transmit the detected scene type of a preview frame to the flash control unit [206G]. The camera framework [206F] is configured to determine the scene type based on machine learning and artificial intelligence.

In furtherance of the aforementioned exemplary embodiment, to capture a media involving capture of several consecutive preview frames, the camera framework [206F] is configured to determine a scene type for capturing each of the several preview frames. For example, to capture a video in the “Auto Mode”, the camera framework [206F] is configured to determine a scene type for each of the several preview frames in video. For example, the camera framework [206F] may determine the scene type for a preview frame to be “outdoor” when the sky is detected in the preview frame. Thereafter, the camera framework [206F] may determine the scene type for the next consecutive preview frame to be “indoor” when walls are detected by in the next consecutive preview frame.

The flash control unit [206G], which is connected to the camera driver [206E], the camera framework [206F] and the flash driver [206H], is configured to dynamically calculate a flash intensity control value based on at least the determined position of the lens [206B], the detected luminance level and the determined scene type. As used herein, the “flash intensity control value” is the value of the intensity of the flash which must be used to capture a natural, correctly exposed media of the preview frame, wherein the media comprises an image, video, panoramic view and the like. The flash control unit [206G] is configured to transmit the calculated value of the flash intensity control to the flash driver [206H]. The flash control unit [206G] dynamically adjusts the intensity of the flash fired by the flash driver [206H] based on the calculated value of the flash intensity control to produce natural and correctly exposed media.

For instance, the flash control unit [206G] dynamically calculates a low value for the intensity of the flash to be fired by the flash driver [206H] if the determined position of the lens [206B] is small and a high luminance level in the preview frame is detected. In another example, the flash control unit [206G] may dynamically calculate a high flash intensity control value for the flash to be fired by the flash driver [206H] if the scene type is determined to be “night” and the position of the lens is such that the scene to be captured is far.

In an embodiment, the present disclosure encompasses that the flash control unit [206G] is configured to convert the dynamically calculated flash intensity control value to be within a scale from 1 to 32, the end values being inclusive. For example, the dynamically calculated flash intensity control value by the flash control unit [206G] is converted to a value, say 25, from a scale of 1 to 32, when a high flash intensity control value is calculated by the flash control unit [206G].

In furtherance of the aforementioned exemplary embodiment, to capture a media involving the capture of several consecutive preview frames, the flash control unit [206G] is configured to dynamically calculate a flash intensity control value based on the determined position of the lens [206B], the detected luminance level and the determined scene type for each of the several preview frames in video till the input to stop the video is received from the user. The dynamically calculated flash intensity control value is then converted to a value within a scale of 1 to 32 for each of the preview frames. For example, the flash intensity control value for a preview frame may be converted to a value 20 when a high flash intensity control value is determined by the flash control unit [206G]. Thereafter, the flash intensity control value for the next consecutive preview frame may be converted to a value 15 when a low flash intensity control value is determined by the flash control unit [206G].

The flash driver [206H], which is connected to the flash control unit [206G], is configured to produce a flash of an intensity calculated by the flash control unit [206G] to capture a media. The present disclosure encompasses that the flash driver [206H] is configured to modulate the flash intensity for each preview frame to capture a media. As used herein in the present disclosure, a “flash” may be a projection of artificial light by the camera [206] to help illuminate a preview frame to capture natural and correctly exposed media of the preview frame.

In furtherance of the aforesaid exemplary embodiment, the flash driver [206H] is configured to produce a flash of an intensity equal to the calculated flash intensity control value by the flash control unit [206G] to capture each of the several preview frames in the video. For example, the flash driver [206H] is configured to produce a flash of an intensity equal to the flash intensity control value calculated by the flash control unit [206G] for capturing each of the several preview frames in video. The flash driver [206H] may produce a flash of an intensity determined for a preview frame by the flash control unit [206G] and produce another flash of a different intensity determined by the flash control unit [206G] for the next consecutive preview frame.

The present disclosure also encompasses within its scope a flash control unit that can be implemented as a separate unit from the camera [206] and is configured to interact with said camera [206] via one or more communication lines. The flash control unit, in such a case, would calculate the flash intensity control value based on the lens position of the camera [206], luminance level of the preview frame and scene type of the preview frame as detected by the camera [206].

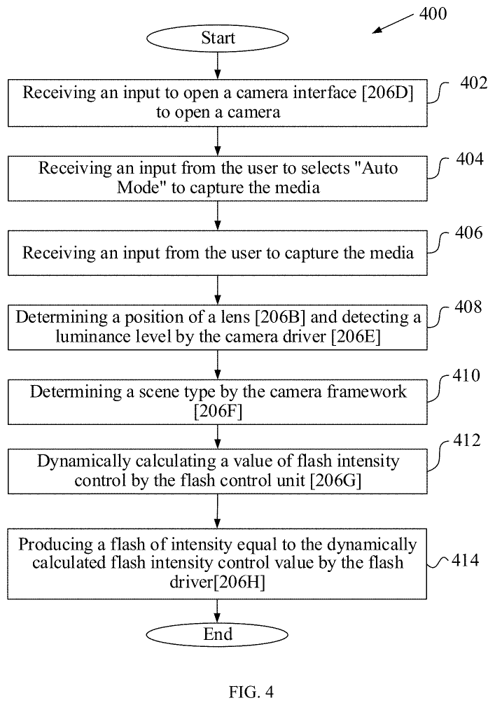

Referring to FIG. 4, FIG. 4 illustrates an exemplary flow chart of a method for providing an intelligent flash intensity control in the camera [206] in accordance with exemplary embodiments of the present disclosure.

The method begins at block 402, where an input is received from the user, by a camera interface [206D], either directly or via the input unit [204], to open a camera [206]. The camera interface [206D] then displays a preview frame to capture the media. The camera interface [206D] may further provide, to the user, one or more options including options for features for capturing a media and flash modes. For example, the camera interface [206D] may include one or more icons for providing filters, colours, flash settings and the like. The user may then select one or more filters or colours to apply on the media.

At block 404, another input is received from the user to select an “Auto Mode” to capture the media. The user selects the “Auto Mode” to capture the media from one of the options for the operation of the flash driver [206H]. The user may select the option for the “Auto Mode” by providing an input to the input unit [204]. For example, the tap on an option of Mode on the touch panel using a finger by the user can enable the “Auto Mode”. When an input is received from the user to select the “Auto Mode”, the camera interface [206D] is configured to interpret the input and enable the mode. When this mode is enabled, a signal is transmitted by the camera interface [206D] to the camera driver [206E] and the camera framework [206F], said signal indicating that the Auto Mode has been activated.

The present disclosure encompasses that the block 404 may be an optional operation, wherein the auto mode will be automatically and by default enabled for any and all media captured by the user using the camera [206].

At block 406, yet another input is received, at the camera interface [206D], from the user to capture a media. For instance, the camera interface [206D] may provide for the user to click on a soft button on a touch panel of the input unit [204] to capture a media using the camera [206].

At block 408, in the Auto Mode, the camera driver [206E] determines a position of the lens [206B] and also detects a luminance level of the preview frame. The position of the lens [206B] is determined when the light passing through the lens is focused on an image sensor [206C]. The camera driver [206E] moves the lens [206B] to achieve the focus of the light rays from the shutter [206A] on the image sensor [206C]. The present disclosure encompasses that the lens [206B] is moved to determine a focal point of the lens [206B]. When the focus is achieved by moving the lens [206B] to a definite position, the camera driver [206E] determines this position of the lens [206B]. The position of the lens [206B] is based on the focal point of the lens [206B].

The present disclosure includes that the position of the lens [206B] may be determined to be within a predefined range. For example, the position of the lens [206B] may be determined to be within a range of 30 mm to infinite. For example, the position of the lens [206B] may be determined to be 40 mm. The present disclosure encompasses that the determined position of the lens [206B] is converted to a value within a scale of 1 to 10, the end values being inclusive, by the camera driver [206E]. For example, the position of the lens [206B] determined by the camera driver [206E] to be 100 mm is converted to a value, say 5, from a scale of 1 to 10.

The luminance level of the preview frame is determined by the camera driver [206E] based on an amount of light in the preview frame. For example, the amount of light of a preview frame may be detected to be 10,000 lux which may then be used to determine a luminance level for the preview frame by the camera driver [206E]. The detected luminance level of a preview frame is then transmitted to the flash control unit [206G] by the camera driver [206E].

In an embodiment, the present disclosure encompasses that the determined luminance level by the camera driver [206E] is mapped onto a value within a scale from 1 to 10, the end values being inclusive. For example, the amount of light in a preview frame detected by the camera driver [206E] is converted to a value, say 2, from a scale of 1 to 10, when the amount of light in the preview frame is 10,000 lux.

At block 410, in the Auto Mode, the camera framework [206F] determines a scene type for the preview frame, said determination being based on machine learning and artificial intelligence. The detected scene type of a preview frame is then transmitted to the flash control unit [206G] by the camera framework [206F].

Thereafter, at block 412, the flash control unit [206F] dynamically calculates a flash intensity control value based on at least the determined position of the lens [206B], the detected luminance level and the determined scene type. As explained above in the present disclosure, the “flash intensity control value” is the value of the intensity of the flash which must be used to capture a natural, correctly exposed media of the preview frame, wherein the media comprises an image, video, panoramic view and the like. Thereafter, the calculated value of the flash intensity control is transmitted to the flash driver [206H] by the flash control unit [206G]. The calculated value of the flash intensity control is used to dynamically adjust the intensity of the flash to be fired by the flash driver [206H] to produce natural and correctly exposed media.

The present disclosure encompasses that the dynamically calculated flash intensity control value is converted to a value within a scale from 1 to 32, the end values being inclusive, by the flash control unit [206G]. For example, the dynamically calculated value of flash intensity control by the flash control unit [206G] is converted to a value, say 25, from a scale of 1 to 32, when a high flash intensity control is determined by the flash control unit [206G].

Finally, at block 414, a flash is produced by the flash driver [206H], with an intensity equal to the dynamically calculated flash intensity control value determined by the flash control unit [206G], to capture the media. The present disclosure encompasses that the flash intensity for each preview frame to capture a media can be modulated by the flash driver [206H].

As evident from the above description, the present disclosure provides for a method and system for an intelligent camera that produces natural and correctly exposed images with the use of flash. The intelligent camera provides for dynamically calculating an intensity of the flash to be used for capturing a media, said calculation being based on a determined position of a lens, a luminance level of the preview frame and a scene type of the preview frame. The present disclosure further ensures that the flash is distributed throughout the media. Therefore, the present disclosure requires less power, doesn't require increase in space and is relatively cheaper while providing additional features for natural and correctly exposed images with the use of flash, and results in significant technical advancement over the prior art systems.

Embodiments of the present disclosure also provide an electronic device. The electronic device may be, but not limited to, a mobile phone, a smart phone, a tablet computer, a telephone, a laptop computer, a wearable device, and a personal digital assistant. The electronic device includes a processor. The processor may call and run a computer program from the memory to implement the method according to the embodiments of the present disclosure. In an embodiment, the electronic device may also include a memory. The processor may call and run the computer program from the memory to implement the method according to the embodiments of the present disclosure. The memory may be a separate device independent of the processor, or may be integrated in the processor.

In an embodiment, the electronic device may further include a transceiver, and the processor may control the transceiver to communicate with other devices, specifically, may send information or data to other devices, or receive information or data sent by other devices. The transceiver may include a transmitter and a receiver. The transceiver may further include antennas, and the number of antennas may be one or more.

In an embodiment, the electronic device has a system for intelligent system performance management according to an embodiment of the present disclosure, and the electronic device can implement the corresponding processes of each method of the embodiment of the present disclosure. For brevity, details are not described herein.

Embodiment of the present disclosure further provides a chip, including a processor. The processor may call and run a computer program from the memory to implement the method according to the embodiments of the present disclosure.

In an embodiment, the chip may further include memory. The processor may call and run the computer program from the memory to implement the method according to the embodiments of the present disclosure. The memory may be a separate device independent of the processor, or may be integrated in the processor.

In an embodiment, the chip may further include an input interface. The processor may control the input interface to communicate with other devices or chips, specifically, may obtain information or data sent by other devices or chips.

In an embodiment, the chip may further include an output interface. The processor may control the output interface to communicate with other devices or chips, specifically, output information or data to other devices or chips.

In an embodiment, the chip can be applied to electronic devices according to the embodiments of the present disclosure, and the chip can implement the corresponding processes of the various methods according to the embodiments of the present disclosure.

It should be understood that the chip mentioned in the embodiments of the present disclosure may also be referred to as system-level chip, system chip, chip system, or system-on-chip chip.

It should be understood that the processor in the embodiments of the present disclosure may be an integrated circuit chip, which has signal processing capability. In the implementation process, each action of the foregoing method embodiment may be implemented by an integrated logic circuit in a processor in the form of hardware or instructions in the form of software. The foregoing processor may be a general-purpose processor, a digital signal processor (DSP), an application specific integrated circuit (ASIC), an existing programmable gate array (Field Programmable Gate Array, FPGA), or other available programming logic devices, discrete gates or transistor logic devices, discrete hardware components. The methods, operations, and logical block diagrams disclosed in the embodiments of the present disclosure may be implemented or executed. The general-purpose processor may be a microprocessor or the processor may be any conventional processor or the like. The operations of the method disclosed in conjunction with the embodiments of the present disclosure may be directly embodied and executed by a hardware decoding processor, or may be executed and implemented by a combination of hardware and software modules in the decoding processor. The software modules may be located in a mature storage medium in the art, such as a random access memory, a flash memory, a read-only memory, a programmable read-only memory, an electrically erasable programmable memory, and a register. The storage medium is located in the memory, and the processor reads the information in the memory and implements the operations of the above method in combination with its hardware.

It can be understood that the memory in the embodiments of the present disclosure may be volatile memory or non-volatile memory, or may include both volatile and non-volatile memory. The non-volatile memory can be read-only memory (Read-Only Memory, ROM), programmable read-only memory (Programmable ROM, PROM), erasable programmable read-only memory (Erasable PROM, EPROM), electronic Erasable Programmable Read Only Memory (Electrically EPROM, EEPROM) or flash memory. The volatile memory may be random access memory (Random Access Memory, RAM), which is used as an external cache. By way of example but not limitation, many kinds of RAM are available, such as static random access memory (Static RAM, SRAM), dynamic random access memory (Dynamic RAM, DRAM), synchronous dynamic random access memory (Synchronous DRAM, SDRAM), double data rate synchronous dynamic random access memory (Double SDRAM, DDR SDRAM), enhanced synchronous dynamic random access memory (Enhanced SDRAM, ESDRAM), synchronous connection dynamic random access memory (Synchlink DRAM, SLDRAM)), and direct memory bus random access memory (Direct Rambus RAM, DR RAM). It should be noted that the memories of the systems and methods described herein are intended to include, but are not limited to these and any other suitable types of memories.

It should be understood that the foregoing memory is exemplary but not limiting, for example, the memory in the embodiments of the present disclosure may also be static random access memory (static RAM, SRAM), dynamic random access memory (dynamic RAM, DRAM), Synchronous dynamic random access memory (synchronous DRAM, SDRAM), double data rate synchronous dynamic random access memory (double data rate SDRAM, DDR SDRAM), enhanced synchronous dynamic random access memory (enhanced SDRAM, ESDRAM), synchronous connection Dynamic random access memory (synch link DRAM, SLDRAM) and direct memory bus random access memory (Direct Rambus RAM, DR RAM), etc. That is to say, the memories in the embodiments of the present disclosure are intended to include but are not limited to these and any other suitable types of memories.

Embodiments of the present disclosure further provide a computer-readable storage medium for storing a computer program.

In an embodiment, the computer-readable storage medium may be applied to the electronic device in the embodiments of the present disclosure, and the computer program causes the computer to execute the corresponding processes in the various methods according to the embodiments of the present disclosure.

In an embodiment, the computer-readable storage medium can be applied to the mobile terminal/terminal device according to the embodiments of the present disclosure, and the computer program enables the computer to execute the corresponding process implemented by the mobile terminal/terminal device in each method of the embodiments of the present disclosure. For the sake of brevity, details are not described here.

Embodiments of the present disclosure provide a computer program product, including computer program instructions.

In an embodiment, the computer program product may be applied to the electronic device in the embodiments of the present disclosure, and the computer program instructions cause the computer to execute the corresponding processes in each method according to the embodiments of the present disclosure. For the sake of brevity, details are not described here.

In an embodiment, the computer program product can be applied to the mobile terminal/terminal device in the embodiments of the present disclosure, and the computer program instructions cause the computer to execute the corresponding process implemented by the mobile terminal/terminal device in each method of the embodiments of the present disclosure. For the sake of brevity, details are not described here.

Embodiments of the present disclosure provide a computer program.

In an embodiment, the computer program can be applied to the electronic device in the embodiment of the present disclosure. When the computer program runs on the computer, the computer is caused to execute the corresponding process in each method according to the embodiments of the present disclosure. Repeat again.

In an embodiment, the computer program can be applied to the mobile terminal/terminal device according to the embodiments of the present disclosure, and when the computer program runs on the computer, the computer is implemented by the mobile terminal/terminal device to perform various methods of the embodiments of the present disclosure. For the sake of brevity, I will not repeat them here.

Those of ordinary skill in the art may realize that the units and algorithm operations of the examples described in conjunction with the embodiments disclosed herein can be implemented by electronic hardware, or a combination of computer software and electronic hardware. Whether these functions are executed in hardware or software depends on the specific application of the technical solution and design constraints. Professional technicians can use different methods to implement the described functions for each specific application, but such implementation should not be considered beyond the scope of this application.

Those skilled in the art can clearly understand that for the convenience and conciseness of the description, the specific working process of the system, device and unit described above can be seen from the corresponding process in the foregoing method embodiments, which will not be repeated here.

In the several embodiments of the present disclosure, it should be understood that the disclosed system, device, and method may be implemented in other ways. For example, the device embodiments described above are only schematic. For example, the division of the units is only a division of logical functions. In actual implementation, there may be other divisions, for example, multiple units or components may be combined or integrated into another system, or some features can be ignored, or not implemented. In addition, the displayed or discussed mutual coupling or direct coupling or communication connection may be indirect coupling or communication connection through some interfaces, devices or units, and may be in electrical, mechanical or other forms.

The units described as separate components may or may not be physically separated, and the components displayed as units may or may not be physical units, that is, they may be located in one place, or may be distributed on multiple network units. Some or all of the units may be selected according to actual needs to achieve the purpose of the solution of this embodiment.

In addition, each functional unit in each embodiment of the present disclosure may be integrated into one processing unit, or each unit may exist alone physically, or two or more units may be integrated into one unit.

If the function is implemented in the form of a software functional unit and sold or used as an independent product, it may be stored in a computer-readable storage medium. Based on such an understanding, the technical solution of the present disclosure essentially or partly contributing to the existing technology or part of the technical solution can be embodied in the form of a software product, and the computer software product is stored in a storage medium, including instructions for enabling a computer device (which may be a personal computer, a server, or a network device, etc.) to perform all or part of the operations of the methods described in the embodiments of the present disclosure. The aforementioned storage media include: U disk, mobile hard disk, read-only memory (Read-Only Memory, ROM), random access memory (Random Access Memory, RAM), magnetic disk or optical disk and other media that can store program codes.

The above is only the specific implementation of the present disclosure, but the scope of protection of the present disclosure is not limited to this, any person skilled in the art can easily think of changes or replacements within the technical scope disclosed in the present disclosure, which should be within the scope of the present disclosure. Therefore, the scope of the present disclosure shall be subjected to the scope of the claims.

What is claimed is:

1. A method for intelligent flash intensity control in a camera, comprising:
determining a position of a lens of the camera, a luminance level of a preview frame and a scene type of the preview frame;
calculating a flash intensity control value based on the position of the lens of the camera, the luminance level of the preview frame and the scene type of the preview frame; and
controlling, based on the flash intensity control value, a flash driver of the camera to produce a flash with an intensity value equal to the flash intensity control value.

2. The method of claim 1, wherein the position of the lens is associated with at least one of:
a focus point of the lens, or
a distance between a scene to be captured and the lens,
wherein the preview frame is a live view of the scene to be captured.

3. The method of claim 1, wherein determining the position of the lens of the camera comprises:
controlling the lens of the camera to move to a first position, wherein light passing through the lens located at first location is focused on an image sensor of the camera; and
determining the first position as the position of the lens of the camera.

4. The method of claim 1, further comprising:
converting the position of the lens into a first value within a first numerical range after determining the position of the lens of the camera, wherein the first value is used for characterizing the position of the lens.

5. The method of claim 1, wherein determining the luminance level of the preview frame comprises:
detecting an amount of light in the preview frame; and
determining the luminance level of the preview frame based on the amount of light in the preview frame.

6. The method of claim 1, further comprising:
converting the luminance level of the preview frame into a second value within a second numerical range after determining the luminance level of the preview frame, wherein the second value is used for characterizing the luminance level of the preview frame.

7. The method of claim 1, wherein determining the scene type of the preview frame comprises:
performing an image analysis on the preview frame; and
determining the scene type of the preview frame based on an image analysis result, wherein the image analysis result is used for characterizing one or more subjects in the preview frame,
wherein the scene type of the preview frame comprises at least one of:
outdoor, indoor, day, night, star, dark, bright, beach, or sea.

8. The method of claim 1, further comprising:
converting the flash intensity control value into a third value within a third numerical range after calculating the flash intensity control value, wherein the third value is used for characterizing the flash intensity control value.

9. The method of claim 1, further comprising:
receiving an input from a user and enabling an auto mode of the camera based on the input from the user;
wherein determining the position of the lens of the camera, the luminance level of the preview frame and the scene type of the preview frame comprises:
determining, in the auto mode of the camera, the position of the lens of the camera, the luminance level of the preview frame and the scene type of the preview frame.

10. An electronic device, comprising:
a processor;
a memory; and
a camera comprising a lens and a flash driver,
wherein the processor, when executing a computer program stored in the memory, is configured to:
determine a position of the lens, a luminance level of a preview frame and a scene type of the preview frame;
calculate a flash intensity control value based on the position of the lens of the camera, the luminance level of the preview frame and the scene type of the preview frame; and
control, based on the flash intensity control value, the flash driver to produce a flash with an intensity value equal to the flash intensity control value.

11. The electronic device of claim 10, wherein the position of the lens is associated with at least one of:
a focus point of the lens, or
a distance between a scene to be captured and the lens,
wherein the preview frame is a live view of the scene to be captured.

12. The electronic device of claim 10, wherein the processor is configured to:
control the lens of the camera to move to a first position, wherein light passing through the lens located at the first position is focused on an image sensor of the camera; and
determine the first position as the position of the lens of the camera.

13. The electronic device of claim 10, wherein the processor is configured to:
convert the position of the lens into a first value within a first numerical range after determining the position of the lens of the camera, wherein the first value is used for characterizing the position of the lens.

14. The electronic device of claim 10, further comprising an image sensor, wherein
the image sensor is configured to detect an amount of light in the preview frame; and
the processor is configured to determine the luminance level of the preview frame based on the amount of light in the preview frame.

15. The electronic device of claim 10, wherein the processor is configured to:
convert the luminance level of the preview frame into a second value within a second numerical range after determining the luminance level of the preview frame, wherein the second value is used for characterizing the luminance level of the preview frame.

16. The electronic device of claim 10, wherein the processor is configured to:
perform an image analysis on the preview frame; and
determine the scene type of the preview frame based on an image analysis result, wherein the image analysis result is used for characterizing one or more subjects in the preview frame,
wherein the scene type of the preview frame comprises at least one of:
outdoor, indoor, day, night, star, dark, bright, beach, or sea.

17. The electronic device of claim 10, wherein the processor is configured to:
convert the flash intensity control value into a third value within a third numerical range after calculating the flash intensity control value, wherein the third value is used for characterizing the flash intensity control value.

18. The electronic device of claim 10, further comprising a camera interface, wherein
the camera interface is configured to receive an input from a user and enable an auto mode of the camera based on the input from the user;
the processor is configured to: determine, in the auto mode of the camera, the position of the lens of the camera, the luminance level of the preview frame, and the scene type of the preview frame.

19. A non-transitory computer-readable storage medium, storing a computer program, which when executed by a computer, causes the computer to perform a method for intelligent flash intensity control in a camera, the method comprising:
determining a position of a lens of the camera, a luminance level of a preview frame and a scene type of the preview frame;
calculating a flash intensity control value based on the position of the lens of the camera, the luminance level of the preview frame and the scene type of the preview frame; and
controlling, based on the flash intensity control value, a flash driver of the camera to produce a flash with an intensity value equal to the flash intensity control value.

20. The non-transitory computer-readable storage medium of claim 19, wherein the one or more programs, when executed by the one or more processors for:
controlling the lens of the camera to move to a first position, wherein light passing through the lens located at first location is focused on an image sensor of the camera; and
determining the first position as the position of the lens of the camera;
converting the position of the lens into a first value within a first numerical range after determining the position of the lens of the camera, wherein the first value is used for characterizing the position of the lens.
